(19) United States
(12) Patent Application Publication
(10) Pub. No.: US 2020/0253182 A1
(43) Pub. Date: Aug. 13, 2020

(54) ICE FISHING HOLE COVER SYSTEM

(71) Applicants: Cory Lindgren, Chisago City, MN (US); Shawna Lindgren, Chisago City, MN (US)

(72) Inventors: Cory Lindgren, Chisago City, MN (US); Shawna Lindgren, Chisago City, MN (US)

(21) Appl. No.: 16/274,892

(22) Filed: Feb. 13, 2019

(51) Int. Cl. A01K 97/01

(52) U.S. Cl. CPC A01K 97/01

(57) ABSTRACT

A cover system configured to selectively limit access to an ice fishing hole defined in a layer of ice. The cover system including a sleeve member and a cover, the sleeve member having a hollow tubular portion and a lip portion, the lip portion surrounding at least a portion of the hollow tubular portion and defining a cover recess having a cover recess depth, the cover shaped and sized to be positioned within the cover recess thereby selectively limiting access to the ice fishing hole, the cover having a cover thickness, the cover thickness being less than the cover recess depth, such that when the cover is positioned within the cover recess, the top surface of the cover is recessed below the top surface of the sleeve member, thereby inhibiting inadvertent removal of the cover from the sleeve member.

### TECHNICAL FIELD

The present disclosure relates generally to ice fishing accessories, and more particularly to a cover system configured to selectively limit access to an ice fishing hole.

### BACKGROUND

Winter sport ice fishing involves drilling or otherwise forming a hole in the layer of ice of a lake, stream or river of a sufficient diameter to accommodate ice fishing equipment, which can include a reel and fishing line assembly. In some cases, the fishermen can fish directly from the unexposed surface of the layer of ice. In other cases, a temporary or permanent fish house having a floor can be utilized to shield the fishermen from the cold winter conditions.

In either case, the open ice fishing hole can present a safety hazard. In particular, the ice fishing hole can present a trip hazard, and in cases where the hole is large enough can enable the fishermen to inadvertently step through the hole and into the icy water. Another problem associated with ice fishing is the loss of valuable items, such as watches, cellular phones, wallets, and the like which can fall into the ice fishing hole and sink to the bottom of the lake, thereby resulting in their permanent loss. Yet another problem associated with ice fishing is maintaining the ice fishing hole in an open, unfrozen condition.

Over the years, various ice fishing hole covers have been developed. Examples of conventional ice fishing covers include U.S. Pat. No. 6,675,523 to Huiras et al. and U.S. Pat. No. 8,943,733 to Katz, the contents of which are incorporated by reference herein to the extent that they do not contradict the teachings of the Present Application. Although such covers generally limit access to the open ice fishing hole, they uniformly fail to adequately maintain their position over the open ice hole during extended use. As such, ice fishing covers of the prior art can easily be inadvertently bumped or kicked out of position, thereby exposing the open ice fishing hole and the inherent hazards associated therewith.

The present disclosure addresses these concerns.

### SUMMARY OF THE DISCLOSURE

Embodiments of the present disclosure provide a cover system configured to selectively limit access to an ice fishing hole defined in a layer of ice by providing a sleeve member configured to be positioned within the ice fishing hole, and a cover configured to securely reside within a cover recess defined in the sleeve member, thereby inhibiting inadvertent removal of the cover from the sleeve member. As such, the cover system can provide safety and protection from inadvertently stepping into the open ice fishing hole, the cover can inhibit valuable articles from falling through the open ice fishing hole, and the cover can limit exposure of the water to cold air, which can aid in maintaining the ice fishing hole in an open, unfrozen condition. In some embodiments, the cover system can include a heater to further aid in maintaining the ice fishing hole in open condition, a light to at least partially illuminate the ice fishing hole, or a convenient mounting bracket for other electronic and fishing tackle accessories.

One embodiment of the present disclosure provides a cover system configured to selectively limit access to an ice fishing hole defined in a layer of ice. The cover system can include a sleeve member and a cover. The sleeve member can have a hollow tubular portion and a lip portion. The hollow tubular portion can have a first end, a second end, and a tubular wall extending therebetween shaped and sized to be positioned within the ice fishing hole. The first end of the hollow tubular portion can be configured to be inserted into the ice fishing hole, and the second end of the hollow tubular portion can be configured to reside in proximity to a surface of the layer of ice when the hollow tubular portion is positioned within the ice fishing hole. The lip portion can be configured to surround at least a portion of the hollow tubular portion in proximity to the second end and can define a top surface and a cover recess having a cover recess depth. The cover can be shaped and sized to be positioned within the cover recess, thereby selectively limiting access to the ice fishing hole. The cover can have a top surface, a bottom surface and a cover thickness. The cover thickness of the cover can be less than the cover recess depth, such that when the cover is positioned within the cover recess, the top surface of the cover is recessed below the top surface of the lip portion, thereby inhibiting inadvertent removal of the cover from the sleeve member.

In one embodiment, the cover recess can be configured to support both a portion of the top surface and an outer edge around an entire periphery of the cover. In one embodiment, the cover can selectively lock to the sleeve member. In one embodiment, the hollow tubular portion can have a length of between about 1 inch and about 24 inches. In one embodiment, the hollow tubular portion can have a diameter of about 4 inches and about 12 inches. In one embodiment, the lip portion can extend outwardly from the hollow tubular portion by a length of between about 1 inch and about 2 inches. In one embodiment, the lip portion can have a thickness of about ⅛ of an inch and about 1 inch. In one embodiment, the hollow tubular portion can have at least one of a circular, square, rectangular, hexagonal, and octagonal cross section. In one embodiment, the hollow tubular portion can include a taper configured to enable stacking of the sleeve members for ease in transportation and storage.

In one embodiment, the cover can be constructed of at least one of an acrylic material, a plastic material, a polycarbonate material, a wood-based material, and a metal-based material. In one embodiment, the cover can be constructed of at least one of a transparent, translucent, and opaque material. In one embodiment, the top surface of the cover can be a textured, nonslip surface. In one embodiment, the cover and sleeve can glow in the dark. In one embodiment, the cover can define at least one fishing line slot. In one embodiment, the cover can define at least one breather hole. In one embodiment, the cover can define at least one electronic cable notch. In one embodiment, the cover system can further include at least one plug configured to selectively seal the at least one breather hole defined in the cover.

In one embodiment, the cover system can include a heater operably coupled to the sleeve member configured to inhibit freezing of the water in the ice fishing hole. In one embodiment, the cover system can include a light operably coupled to the sleeve member configured to provide illumination in the ice fishing hole. In one embodiment, the cover can include a solar panel configured to power one or more accessories. In one embodiment, the sleeve member can include a mounting bracket for at least one of an underwater camera, flasher, fish graph, and light, and fishing tackle accessories. In another embodiment, a reflective material or material with insulating properties is incorporated into the sleeve to add more protection.

Another embodiment of the present disclosure provides a method of selectively limiting access to an ice fishing hole defined in a layer of ice. The method can include the steps of inserting a sleeve member having a hollow tubular portion and a lip portion into the ice fishing hole, wherein the hollow tubular portion has a first end, a second end, and a tubular wall extending therebetween shaped and sized to be positioned within the ice fishing hole, the first end of the hollow tubular portion can be configured to be inserted into the ice fishing hole, and the second end of the hollow tubular portion can be configured to reside in proximity to a surface of the layer of ice when the hollow tubular portion is positioned within the ice fishing hole, the lip portion can surround at least a portion of the hollow tubular portion in proximity to the second end and can define a top surface and cover recess having a recess depth; and positioning a cover within the recess access thereby selectively inhibiting access to the ice fishing hole, wherein the cover has a top surface, a bottom surface, and a cover thickness, the cover thickness of the cover being less than or equal to the cover recess depth, such that when the cover is positioned within the cover recess, the top surface of the cover is recessed below or flush with the top surface of the lip portion, thereby inhibiting inadvertent removal of the cover from the sleeve member.

In yet another embodiment of the invention, the sleeve can provide or enhance darkness by deflecting sunlight from the hole.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a cover system, in accordance with an embodiment of the disclosure.

FIG. 2 is a plan view depicting the cover system of FIG. 1.

FIG. 3A depicts an alternative cover design having three breather holes, in accordance with an embodiment of the disclosure.

FIG. 3B depicts an alternative cover design having no breather holes, in accordance with an embodiment of the disclosure

FIG. 4A depicts an alternative cover design having six breather holes, in accordance with an embodiment of the disclosure.

FIG. 4B depicts an alternative cover design having five breather holes, in accordance with an embodiment of the disclosure.

FIG. 4C depicts an alternative cover design having a wide fishing line slot, in accordance with an embodiment of the disclosure.

FIG. 5 is a plan view depicting a cover system having a covered locking mechanism, in accordance with an embodiment of the disclosure.

FIG. 6 is a perspective view depicting a cover system including one or more electronic accessories, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

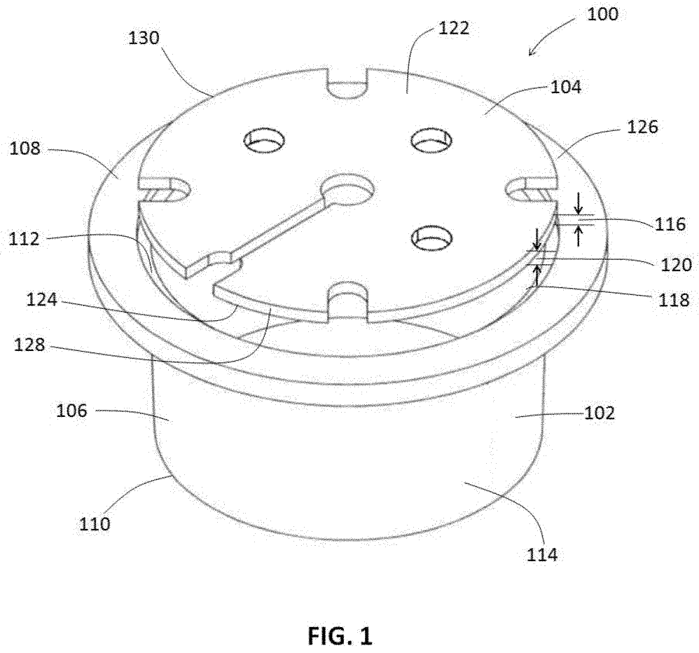

Referring to FIG. 1, a cover system 100 configured to selectively limit access to an ice fishing hole is depicted in accordance with an embodiment of the disclosure. The cover system 100 can be utilized for permanent outdoor, portable fish house and direct-on-ice fishing applications to provide additional safety and protection from inadvertently stepping into or falling into an open ice fishing hole (as well as reduce the likelihood of a small child falling into a large ice fishing hole), preventing loose objects (e.g., watches, cell phones, mobile devices, keys, wallets, etc.) from falling under the ice and being lost or damaged, extend the time frame of the ice fishing hole freezing over as a result of exposure to cold weather, and reduce exposure of the ice fishing hole to light, while providing easy access to fishing tackle and associated electronics.

The cover system 100 can include a sleeve member 102 and a cover 104. The sleeve member 102 can include a hollow tubular portion 106 and a lip portion 108. The hollow tubular portion 106 can include a first end 110, a second end 112, and a tubular wall 114 extending between the first end 110 and the second end 112. In one embodiment, the tubular wall 114 can be shaped and sized to be positioned within an ice fishing hole defined in a layer of ice. For example, in one embodiment, the tubular wall 114 can have a circular cross-section, having a diameter of between about 4 inches and about 12 inches. Other tubular wall 114 configurations are also contemplated; for example, in other embodiments, the tubular wall 114 can have a square, rectangular, hexagonal, octagonal, other polygonal, elliptical, or irregular cross-section.

The first end 110 of the hollow tubular portion 106 can be configured to be inserted into the ice fishing hole, such that the second end 112 of the hollow tubular portion 106 is positioned in proximity to a surface of the layer of ice, when the hollow tubular portion 106 is positioned within the ice fishing hole. In some embodiments, the length of the tubular wall 114 extending between the first end 110 and the second end 112 can be sized to extend the entire depth of the layer of ice defining the ice fishing hole.

The cover system 100 can be utilized in all ice fishing conditions, for example fishing directly in the elements, and a portable house, or any permanent shack or wheelhouse. In some embodiments, the sleeve member 102 can be designed to accommodate the floor holes defined in permanent shack or wheelhouse of a variety of manufacturers. Where the cover system 100 is used in conjunction with a fishing house having a floor, the hollow tubular portion 106 can be sized to extend from a top surface of the floor to the top surface of the layer of ice or through at least a portion of the ice fishing hole. For example, in one embodiment, the tubular wall 114 can have a length of between about 1 inch and about 18 inches.

The lip portion 108 can surround at least a portion of the hollow tubular portion 106 in proximity to the second end 112. For example, in one embodiment, the lip portion 108 can completely encircle or surround the hollow tubular portion 106. The lip portion 108 can define a top surface 116 and a cover recess 118 having a cover recess depth 120. In one embodiment, the cover recess 118 can have a depth 120 of between about ⅛ or greater. In one embodiment, the lip portion 108 can extend outwardly from the hollow tubular portion 106 by a length of between about 1 inch and about 2 inches, thereby inhibiting the hollow tubular portion 106 from traversing entirely through the ice fishing hole when positioned therein. In one embodiment, the lip portion 108 can have a thickness of about ⅛ of an inch or greater.

In one embodiment, the tubular wall 114 can include a taper or other beveled shape (e.g., the diameter or perimeter of the first end 110 can be smaller than the diameter or perimeter of the second end 112), thereby enabling the sleeve member 102 to be stacked with one or more other sleeve members in a nested configuration for ease in transportation and storage. For example, in one embodiment, a plurality of stacked cover systems 100 can be carried within a standard sized five or six gallon bucket.

The cover 104 can be shaped and sized be positioned within the cover recess 120, thereby selectively limiting access to the ice fishing hole. The cover 104 can have a top surface 122, a bottom surface 124, and a cover thickness 126. In one embodiment, the cover thickness 126 can be less than (e.g., smaller than) the cover recess depth 120. For example, where the cover recess depth 120 can have a depth of between about ¼ of an inch and about ¾ of an inch, the cover can have a thickness 126 of about ⅛ of an inch or greater. Accordingly, in this embodiment, the top surface 122 of the cover 104 can be recessed below the top surface 116 of the lip portion 108, thereby inhibiting inadvertent removal of the cover 104 from the sleeve member 102. That is, the cover 104 can be recessed into the sleeve member 102 when properly positioned, thereby not protruding from the surface of the ice or floor in a manner that directly exposes the peripheral edge 130 of the cover 104.

In one embodiment, the cover recess 118 can be configured to provide support to both in engaging portion of the bottom surface 124 of the cover, and to an outer edge 128 surrounding the periphery 130 of the cover 104. In one embodiment, the lip portion 108 of the sleeve member 102 can be configured to provide 360° of support to a portion of the bottom surface 124 and outer edge 128 of the cover 104, which can serve to inhibit the cover 104 from slipping out of position when stepped on or inadvertently kicked.

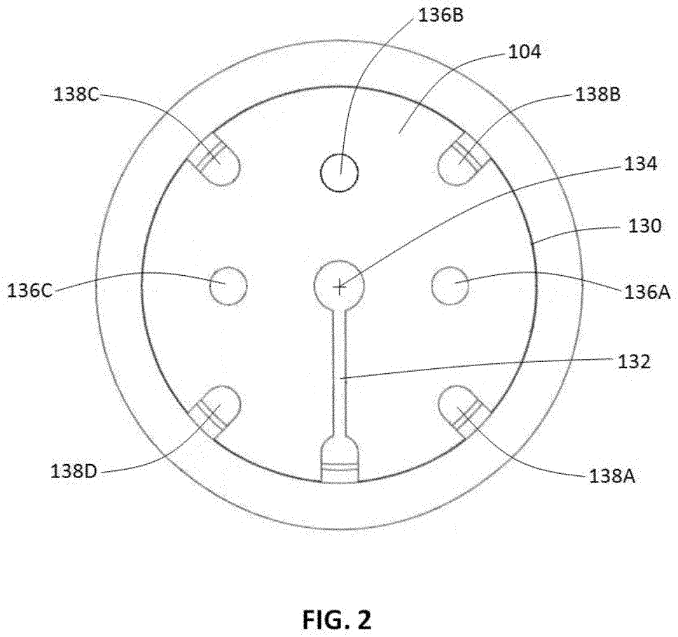

With additional reference to FIG. 2, the cover 104 can define at least one fishing line slot 132. For example, in one embodiment, the fishing line slot 132 can extend from a periphery 130 of the cover 104 to an approximate center 134 of the cover 104. The fishing line slot 132 defined in the cover 104 can be a properly sized to enable bait and tackle removal without removal of the cover 104 from the sleeve member 102, when a fish is not on the line. When a fish is on the line, breather holes 136 and electronic cable matches 138 can provide a grip to aid a user and quickly and easily removing the cover 104 from the sleeve member 102.

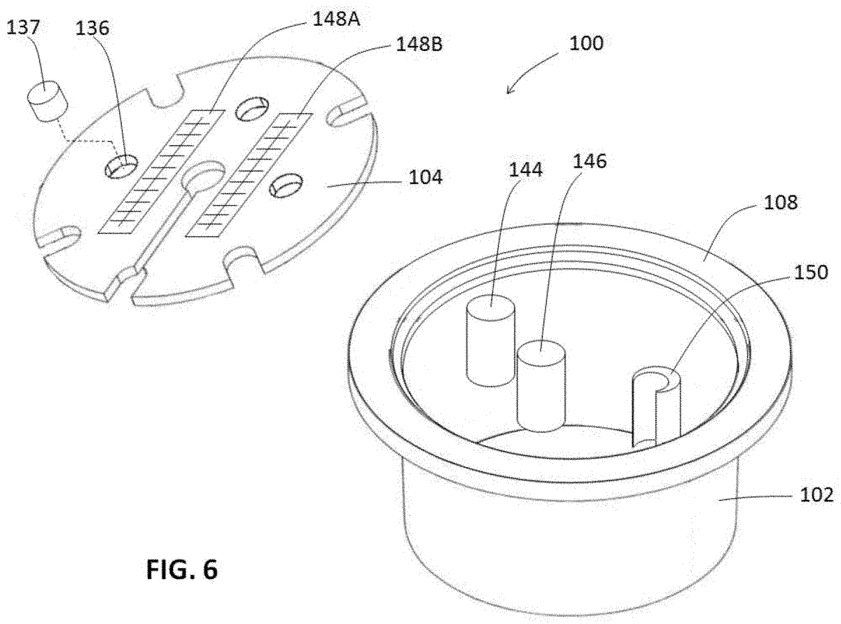

The cover system 100 can be used to extend the usable timeframe of an ice fishing hole, by inhibiting the ice fishing hole from freezing over by reducing wind exposure and limiting exposure of the ice fishing hole to the cold air in proximity to the surface of the ice. In some embodiments, the cover system 100 can include a breathable cover, which can include one or more breather holes 136. For example, in one embodiment, the cover 104 can include three breather holes 136A-C. In some embodiments, one or more plugs 137 (as depicted in FIG. 6) can be utilized to selectively plug the one or more breather holes 136, to accommodate a fisherman's preference, depending on the weather conditions. In some embodiments, the cover system 100 can further include a heater 144 (as depicted in FIG. 6), which can be powered by one or more solar panels 148A/B positioned on either the cover 104 or sleeve member 102.

In one embodiment, the cover 104 can include at least one electronic cable notch 138. For example, in one embodiment, the cover system 100 can include a plurality of electronic cable matches 138 configured to provide multiple entry options for cables and other electronics in the ice fishing hole.

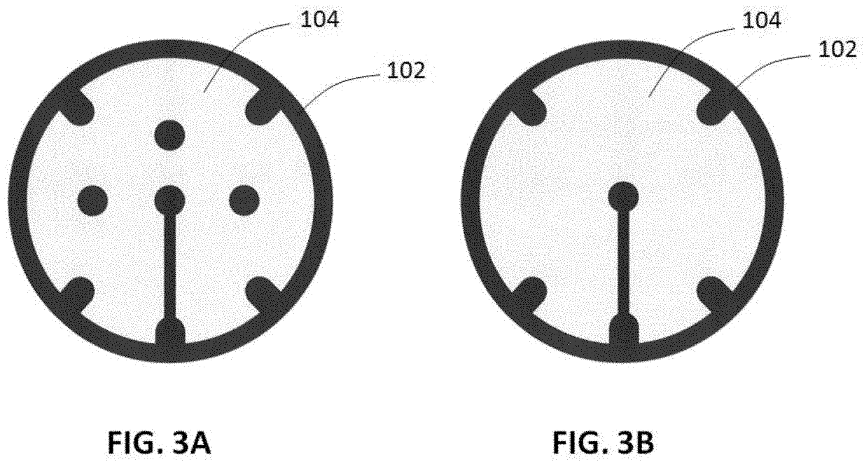

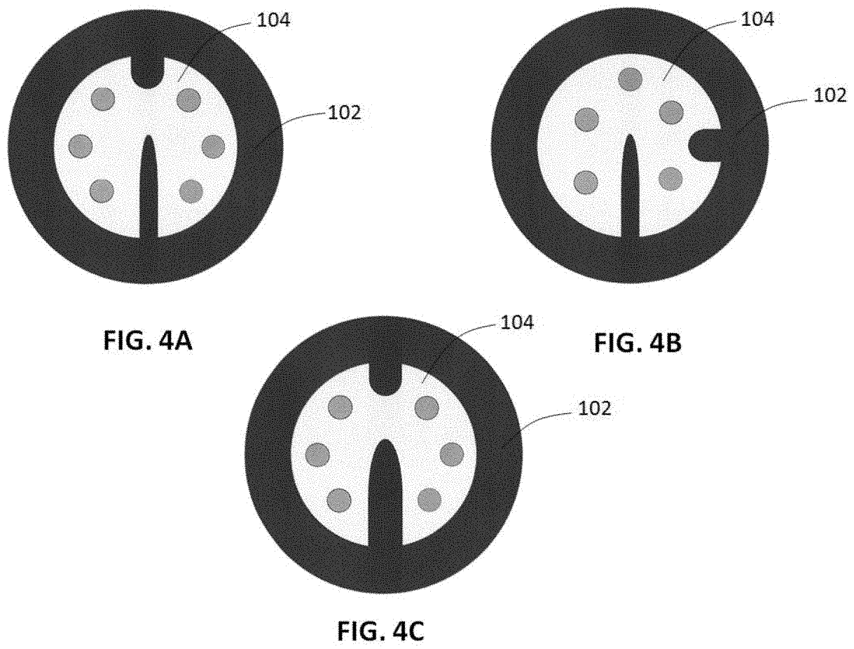

The cover 104 can be constructed of at least one of an acrylic material, a plastic material, a polycarbonate material, a wood based material, and a metal-based material. In one embodiment, the cover 108 can be constructed of at least one of a transparent, translucent and opaque material. For example, in one embodiment, the cover can be clear to enable a fisherman to see into the ice fishing hole, even when the ice fishing hole is covered. In another embodiment, the cover 104 can be a smoky translucent color, or a solid opaque color. In one embodiment, the top surface 122 of the cover 104 can be dimpled or otherwise textured as a nonslip or nonskid surface to reduce the likelihood of individuals slipping on the cover. The cover 104 can be designed to support the full weight of an adult, if stepped on. For example, in one embodiment, the cover 104 can support up to 500 pounds. Although ice fishing holes of about 8 inches and about 10 inches are most common, the cover system 100 can be configured to cover ice fishing holes of between about 4 inches and about 12 inches or more. Other non-limiting, exemplary cover 104 configurations are depicted in FIGS. 3A-B and 4A-C.

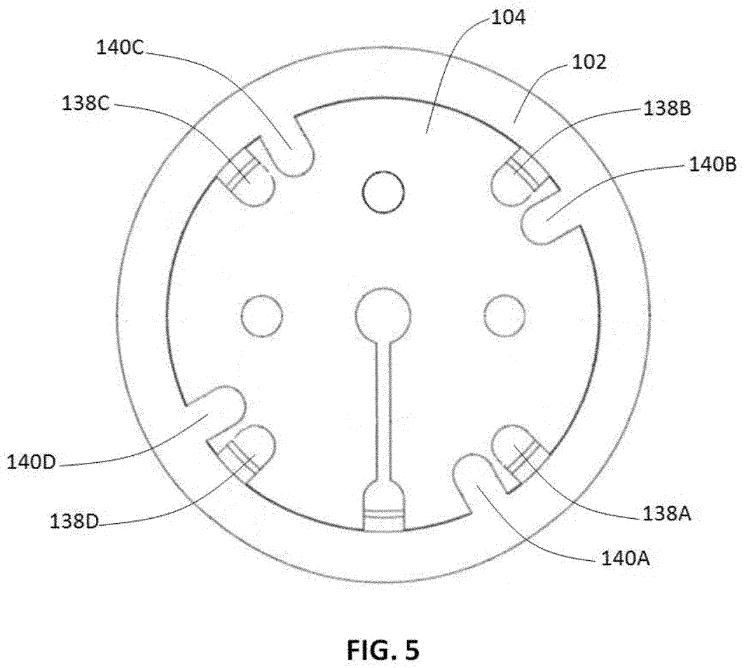

With reference to FIG. 5, in one embodiment, the cover system 100 can include a locking mechanism configured to selectively lock the cover 104 to the sleeve member 102. For example, in one embodiment, the locking mechanism can include one or more of tabs 140 extending inwardly from the lip portion 108. In this embodiment, the one or more electronic cable notches 138A-D can be aligned with the one or more tabs 140 when the cover 104 is positioned on the sleeve member 102, such that when the cover 104 is positioned within the cover recess 118 of the lip portion 108, the one or more tabs 140 are positioned above the top surface 122 of the cover 104. The cover 104 can then be rotated either clockwise or counterclockwise to misalign the one or more tabs 140A-D and the one or more electronic cable notches 138A-D, thereby locking the cover 104 to the sleeve member 102, so as to further inhibit inadvertent removal of the cover 104 from the sleeve member 102.

With reference to FIG. 6, the cover system 100 can further include one or more powered accessories, which can be selectively mountable to the sleeve member 102, for example an inner surface of the tubular wall 114. In one embodiment, the cover system 100 can include a heater 144 configured to inhibit freezing of water in the ice fishing hole. The heater 144 can include a resistive heating element, or an agitator configured to stir the water to inhibit freezing. In one embodiment, the cover system 100 can include a light 146, such as an LED light, configured to illuminate at least a portion of the ice fishing hole or the water below the ice fishing hole to enable a fisherman to see their bait and other fishing tackle below the surface of the water. In another embodiment, cover system can include a reflective or insulating material.

The heater 144, light 146 or other powered accessory can be powered via a solar panel 148A-B or external battery. In one embodiment, the solar panel 148 can be operably coupled to the top surface 122 of the cover 104. In another embodiment, the solar panel 148 can be operably coupled to the lip portion 108 of the sleeve member 102. In one embodiment, the sleeve member 102 can further include a mounting bracket 150 other accessories, such as an underwater camera, flasher, fish graph, or the like, and fishing tackle accessories. Accordingly, in this embodiment, the cover system 100 can serve as a stable platform for a variety of below the water surface accessories.

In operation, a fisherman or other user of the cover system can first form an ice fishing hole in a layer of ice, for example via an auger. Once the ice fishing hole has been formed, the user can insert the hollow tubular portion 106 of the sleeve member 102 into the ice fishing hole, such that the first end 110 of the hollow tubular portion 106 is inserted into the ice fishing hole, and the second end 112 of the hollow tubular portion 106 resides in proximity to a surface of the layer of ice. The lip portion 108, which can be positioned in proximity to the second end 112 of the hollow tubular portion 106 can also be positioned on a surface of the layer of ice. Alternatively, if an ice fishing house is utilized, the lip portion 108 can be positioned on a floor of the ice fishing house. A user can position a cover 104 within the cover recess 118 formed in the lip portion 108, thereby selectively limiting access to the ice fishing hole. In some embodiments, the thickness 126 of the cover 104 can be less than the cover recess depth 120, such that when the cover 104 is positioned within the cover recess 118, the top surface 122 of the cover 104 is recessed below the top surface 116 of the lip portion 108, thereby inhibiting inadvertent removal of the cover from the sleeve member. In an alternate embodiment, cover 104 may be flush with the top surface 116 of the lip portion 108.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A cover system configured to selectively limit access to an ice fishing hole defined in a layer of ice, the cover system comprising:
a sleeve member having a hollow tubular portion and a lip portion, the hollow tubular portion having a first end, a second end, and a tubular wall extending therebetween shaped and sized to be positioned within the ice fishing hole, the first end of the hollow tubular portion configured to be inserted into the ice fishing hole, and the second end of the hollow tubular portion configured to reside in proximity to a surface of the layer of ice when the hollow tubular portion is positioned within the ice fishing hole, the lip portion surrounding at least a portion of the hollow tubular portion in proximity to the second end and defining a top surface and a cover recess having a cover recess depth; and
a cover shaped and sized to be positioned within the cover recess thereby selectively limiting access to the ice fishing hole, the cover having a top surface, a bottom surface and a cover thickness, the cover thickness of the cover being equal to or less than the cover recess depth, such that when the cover is positioned within the cover recess, the top surface of the cover is flush with or recessed below the top surface of the lip portion, thereby inhibiting inadvertent removal of the cover from the sleeve member.

2. The cover system of claim 1, wherein the cover recess provides support to both a portion of the bottom surface and an outer edge around an entire periphery of the cover.

3. The cover system of claim 1, wherein the cover selectively locks to the sleeve member.

4. The cover system of claim 1, wherein the hollow tubular portion has a length of between about 1 inches and about 18 inches.

5. The cover system of claim 1, wherein the hollow tubular portion has a diameter of between about 4 inches and about 12 inches.

6. The cover system of claim 1, wherein the lip portion extends outwardly from the hollow tubular portion at a length of between about 1 inch and about 2 inches.

7. The cover system of claim 1, wherein the lip portion has a thickness of between about ⅛ of an inch and about 1 inch.

8. The cover system of claim 1, wherein the hollow tubular portion has at least one of a circular, square, rectangular, hexagonal, and octagonal cross section.

9. The cover system of claim 1, wherein the hollow tubular portion includes a taper configured to enable stacking of sleeve members for ease in transportation and storage.

10. The cover system of claim 1, wherein the cover is constructed of at least one of an acrylic material, a plastic material, a polycarbonate material, a wood-based material, and a metal-based material.

11. The cover system of claim 1, wherein the cover is constructed of at least one of a glow in the dark, transparent, translucent and opaque material.

12. The cover system of claim 1, wherein the top surface of the cover as a textured, nonslip surface.

13. The cover system of claim 1, wherein cover defines at least one fishing line slot.

14. The cover system of claim 1, wherein cover defines at least one breather hole.

15. The cover system of claim 1, wherein cover defines at least one electronic cable notch.

16. The cover system of claim 1, further comprising a heater operably coupled to the sleeve member configured to inhibit freezing of water in the ice fishing hole.

17. The cover system of claim 1, further comprising a light operably coupled to the sleeve member configured to provide illumination in the ice fishing hole.

18. The cover system of claim 1, wherein the cover includes a solar panel configured to power one or more accessories.

19. The cover system of claim 1, wherein the sleeve member includes a mounting bracket for at least one of an underwater camera, flasher, fish graph, and light.

20. A method of selectively limiting access to an ice fishing hole defined in a layer of ice, the method comprising:
inserting a sleeve member having a hollow tubular portion and a lip portion into the ice fishing hole, wherein the hollow tubular portion has a first end, a second end, and a tubular wall extending therebetween shaped and sized to be positioned within the ice fishing hole, the first end of the hollow tubular portion configured to be inserted into the ice fishing hole, and the second end of the hollow tubular portion configured to reside in proximity to a surface of the layer of ice when the hollow tubular portion is positioned within the ice fishing hole, the lip portion surrounding at least a portion of the hollow tubular portion in proximity to the second end and defining a top surface and a cover recess having a cover recess depth; and
positioning a cover within the cover recess thereby selectively limiting access to the ice fishing hole, wherein the cover has a top surface, a bottom surface and a cover thickness, the cover thickness of the cover being less than the cover recess depth, such that when the cover is positioned within the cover recess, the top surface of the cover is recessed below the top surface of the lip portion, thereby inhibiting inadvertent removal of the cover from the sleeve member.
